(19) United States
(12) Patent Application Publication
(10) Pub. No.: US 2006/0275552 A1
(43) Pub. Date: Dec. 7, 2006

(54) Method and apparatus for automated paint application

(76) Inventors: Timothy Vendlinski, Antrim, NH (US); Linda Holka, Antrim, NH (US)

Correspondence Address: Raymond M. Galasso;Galasso & Associates LP, P.O. Box 26503, Austin, TX, 78755-0503, US

(21) Appl. No.: 11/144,189

(22) Filed: Jun. 4, 2005

(51) Int. Cl. B05D 7/00; B05C 5/00; B05D 1/02

(52) U.S. Cl. 427/421.1; 118/300

(57) ABSTRACT

An apparatus for applying a coating material such as paints or sealants, to a desired surface area, such as a wall, building or a billboard. The apparatus includes at least two vertical support members that are laterally supported by a horizontally secured beam. In between the vertical support members is a track that is movably secured generally parallel to the horizontal beam and can traverse up and down along the two vertical support members. A paint assembly is movably secured to the track. The paint assembly is used to store and spray the paint onto the desired surface and can traverse along the track. The apparatus is connected to and controlled by a control system. The control system allows the user to input the dimensions of the surface to be painted as well as the desired image to be painted. An image corresponding to the image in the control system can be painted onto the surface whereby the control system controls the manipulation of the painting of the image by the paint assembly, by properly positioning the paint assembly vertically and horizontal.

### FIELD OF THE INVENTION

The present invention relates to a paint application apparatus and method, more specifically but not by way of limitation, to an electrical powered system for painting structures such as walls, buildings, and billboards.

### BACKGROUND

Applying paint to large-scale items such as buildings, walls and billboards usually requires the involvement of many skilled workers to accomplish the task. These structures present difficult painting problems and require a significant investment of time. The skilled workers painting these structures usually require assistance from devices such as ladders, scaffolding or automated lifters. Workers also use a variety of paint application devices such as brushes and rollers. Complicated tasks such as murals on building walls usually require specially trained artists and equipment, which can result in a significant investment of time and financial resources.

While conventional methods of paint application to large-scale structures perform satisfactorily, no current devices eliminate the need for skilled workers and assistance devices. Accordingly, there is a need for a paint application apparatus and a method to apply paint and other suitable coating materials in general or graphical manner to large-scale items without the need for skilled workers, painters, and extensive equipment.

### SUMMARY OF THE INVENTION

It is an object of the present invention to provide a portable painting apparatus alternatively configurable to paint a plurality of large-scale items.

It is another object of the present invention to provide a portable painting apparatus alternatively configurable to paint a plurality of large-scale items that is operated by an automated control system.

Yet another object of the present invention is to provide a painting apparatus that provides a method to simultaneously utilize multiple sources of paint.

It is a further object of the present invention to provide a painting apparatus operated by an automated control system that is permanently affixed to a structure such as a paint booth.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a perspective view of an embodiment of the present invention; and

FIG. 2 illustrates an enlarged detailed view of a partial section of an embodiment of the present invention.

### DETAILED DESCRIPTION

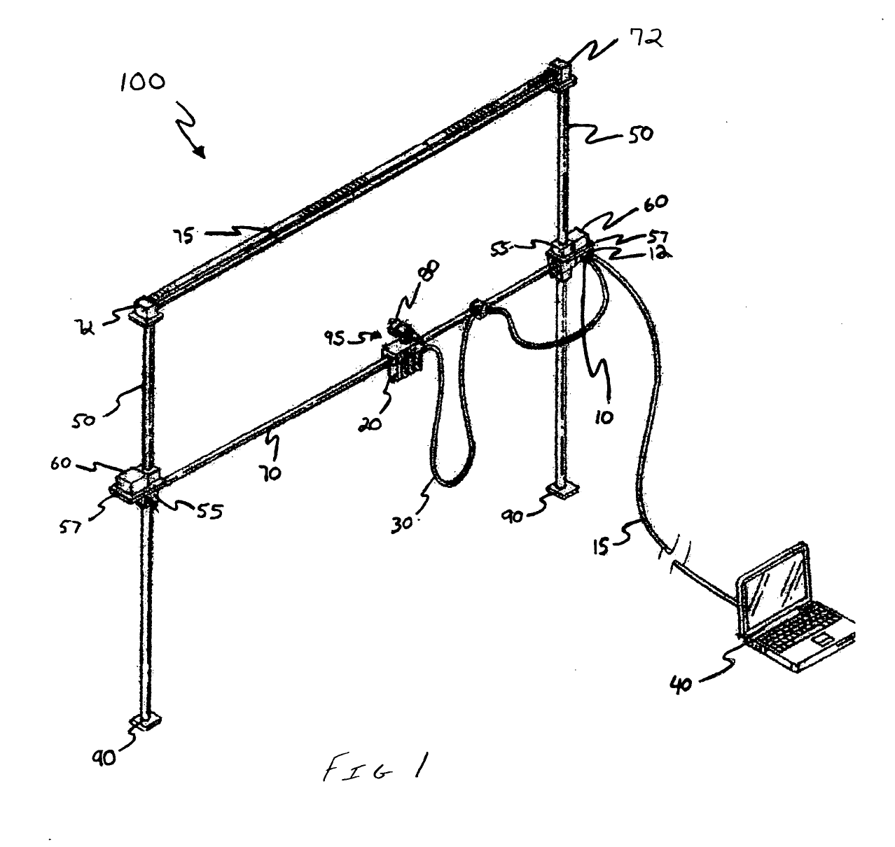

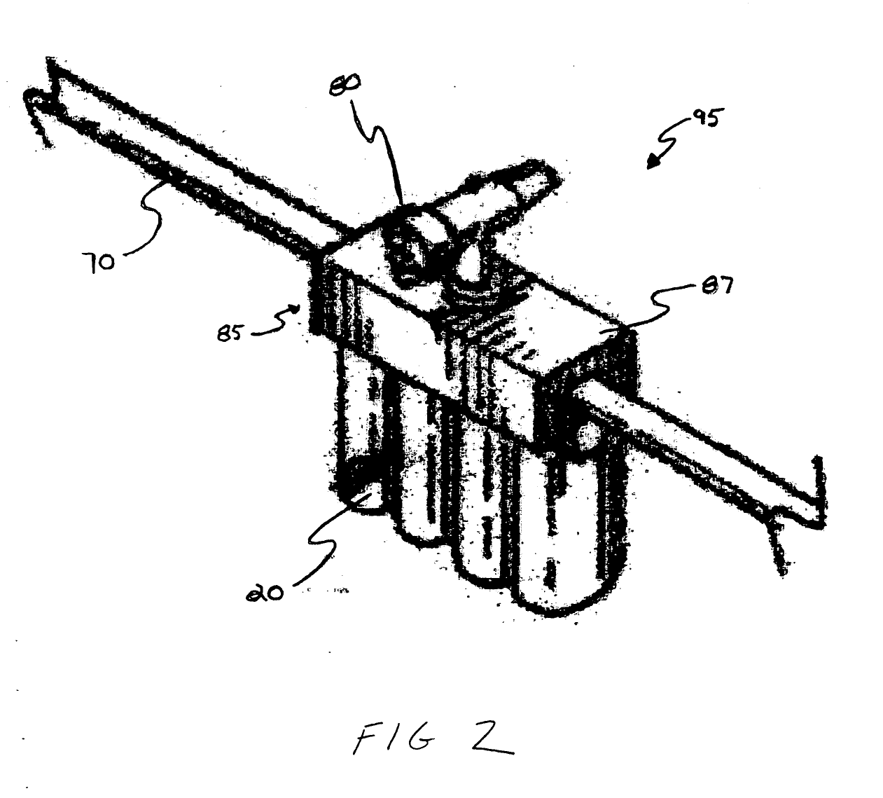

Referring to the embodiments in FIGS. 1 and 2 and wherein like elements are designated with identical reference numerals throughout the views and figures and wherein various elements depicted are not necessarily drawn to scale, and in particular FIG. 1, there is illustrated an automated paint application apparatus 100 constructed according to the principles of the present invention.

The automated paint application apparatus 100 comprises of two perpendicular vertical support members 50 generally square in shape mounted in parallel each superposed to an attachment mechanism 90. The attachment mechanism 90 is releasably secured to one end of each of the vertical support members 50. The attachment mechanism 90 allows the vertical support members 50 to be releasably secured to a horizontal support structure such as but not limited to the ground. The attachment mechanism 90 is a flat, generally square-shaped piece of steel or other suitable material with apertures. The apertures allow for fastening by mechanical methods, such as but not limited to bolts, to a horizontal support structure. Mounted interposed to the vertical support members 50 is a horizontal support beam 75. The horizontal support beam 75 provides lateral support for the assembled automated paint application apparatus 100. The horizontal support beam 75 is demountably attached to one end of each the vertical support members 50. The horizontal support beam 75 is mounted to one end of each of the vertical support members 50 with an attachment bracket 72. The attachment bracket 72 is a universal coupling constructed of metal or other suitable material. The attachment bracket 72 has two apertures perpendicular to each other and are of shape to be mated with the vertical support members 50 and the horizontal support beam 75. The attachment bracket 72 allows one end of the vertical support members 50 to be inserted while simultaneously allowing one end of the horizontal support beam 75 to be inserted perpendicular to the adjacent vertical support members 50.

In general axial alignment with the horizontal support beam 75 interposed to the vertical support members 50 is a horizontal support track 70. Each opposing end of the horizontal support track 70 is releasably secured by suitable mechanical methods to a vertical coupling 55. The vertical coupling 55 is surroundably mounted to each vertical support member 50. To each vertical coupling 55 perpendicularly secured by suitable methods such as welding and externally directed from the opposite vertical support members 50 is a mounting plate 57. The mounting plate 57 is a flat generally square-shaped piece of steel or other suitable material. The mounting plate 57 has apertures to allow fastening by suitable mechanical methods of a vertical movement device 60. Superposed on each mounting plate 57 is a vertical movement device 60. The vertical movement device 60 consists of but is not limited to a common electric motor with a shaft and pinion gear. The vertical movement device 60 is fastened to the mounting plate 57 by suitable mechanical methods such as but not limited to steel bolts. The vertical movement device 60 axially moves in a Y-direction, the horizontal support track 70 along the vertical support members 50. Affixed to one mounting plate 57 adjacent a vertical movement device 60 is a power supply 10. The power supply 10 is mechanically mounted to the mounting plate 57 by suitable mechanical methods such as but not limited too steel screws. The power supply 10 supplies electrical current to each vertical movement device 60.

Demountably attached to the horizontal support track 70 is a paint assembly 95. The paint assembly 95 traverses along the horizontal support track 70 in an X-axis direction by way of a horizontal movement device 85. The horizontal movement device 85 is encased in a housing 87 that is surroundably mounted to the horizontal support track 70. The horizontal movement device 85 consists of but is not limited to a common electric motor configured with a shaft and pinion gear. Secured superposed to the housing 87 and rotatably mounted is the spray nozzle 80. Beneath the spray nozzle 80 releasably secured to the housing 87 are a plurality of paint storage cells 20.

One end of a wiring harness 30 is mated to the horizontal movement device 85 and is releasably secured to the horizontal support track 70. The opposing end of the wiring harness 30 is secured to the power supply 10. Juxtaposed to the wiring harness 30 connection on the power supply 10 is a standard 120V junction box 12 to temporarily connect the automated paint application apparatus 100 to an available power source and to allow the automated paint application apparatus 100 to be connected to a control system 40. Also connected to the power supply 10 is one end of the interface cable 15. The opposite end of the interface cable 15 is connected to the control system 40. The interface cable 15 allows the automated paint application apparatus 100 to be controlled by the portable control system 40. The portable control system 40 uses a plurality of software programs to direct the movement of the spray nozzle 80 and the movement of the paint assembly 95 along the horizontal support track 70. The portable control system 40 also directs the movement of the horizontal support track 70 along the two vertical support members 50 and controls the flow of paint from the plurality of paint storage cells 20 thus facilitating the application of a paint coating to the desired surface.

Now referring to FIG. 1, the vertical support members 50 consist of a single piece of aluminum tubing or other suitable material of desired length generally square in shape. The vertical support members 50 contain a row of a plurality of apertures on one side designed for meshing with the pinion gear teeth of the vertical movement device 60. The pinion gear teeth connect with the plurality of apertures as the gear rotates to facilitate the movement of the horizontal support track 70 along the vertical support members 50 in a downward-upward movement. This could be equated as to movement along a Y-axis.

Although it is not shown, it is contemplated within the scope of the present invention that numerous configurations of the vertical support members 50 are possible. The vertical support members 50 could be a plurality of small segments in length. These segments are then mechanically fastened using suitable methods to configure the vertical support members 50 to a desired length for the particular application needed.

The vertical support members 50 could also be configured in a manner such as but not limited to common fiberglass tent poles. As with the tent poles, the vertical support members 50 would consist of a plurality of segments each segment having a tapered end to allow insertion into the contiguous segment. The segments of the vertical support members 50 would have an elastic cord positioned internally that would connect the entire plurality of segments. The vertical support members 50 would be manufactured by suitable methods to offer a variety of predetermined lengths.

It is also contemplated that sensors utilizing such things as magnetism or lasers could be integrated into the vertical support members 50. The sensors would allow the automated paint application apparatus 100 to detect the area desired for coating and assist in the control of the paint assembly 95 all being generally operated by the control system 40.

Yet another possible configuration of the vertical support members 50 is that in place of the apertures to mesh with a pinion gear configured to the vertical movement device 60, a groove would exist to mate with a frictionally annular device that would facilitate the movement of the horizontal support track 70 in a downward-upward movement along the vertical support members 50. Those skilled in the art will recognize that many alternatives exist which could be used in place of and/or in conjunction with the methods and materials suggested herein to achieve the functionality of the vertical support members 50.

Still referring to FIG. 1, the horizontal support track 70 consists of a single piece of aluminum tubing or other suitable material of a desired length generally square in shape. The horizontal support track 70 contains a row of apertures on one side adapted to mesh with the pinion gear teeth of the horizontal movement device 85. The horizontal movement device 85 traverses the horizontal support track 70. This could be equated to an X-axis direction. Each opposing end of the horizontal support track 70 is releasably secured to the vertical coupling 55 by suitable mechanical fasteners such as but not limited to steel screws.

Alternate arrangements of the embodiment of the horizontal support track 70 while not shown are contemplated within the scope of the present invention. More specifically, but not limited to, an additional member mounted perpendicular to the horizontal support track 70 could be releasably secured in order to provide a third, Z-axis, movement for the paint assembly 95 to assist in coating applications of three dimensional objects such as but not limited too automobiles, buses, aircraft and motorcycle gas tanks. Although not shown it is contemplated within the scope of this invention that the horizontal support track 70 could be manufactured in at least all but not limited to the configurations and principles of the vertical support members 50 as suggested herein.

Now referring to FIG. 2, the paint assembly 95 is common paint sprayer such as but not limited to an airless paint sprayer or aerosol paint sprayer. The spray nozzle 80 is constructed according to well-known manufacturing techniques in the field of manufacturing paint spray nozzles. The spray nozzle 80 is rotatably mounted superposed on the housing 87. The spray nozzle 80 has a predetermined orifice sized for spraying paint at a desired volume and rate. Although it is not shown, it is contemplated within the scope of this invention that alternate spray nozzles 80 could be attached with a different orifice to vary the degrees of spray pattern and volume for painting the desired item. Those skilled in the art will recognize that a variety of different paint spray nozzles and configurations could be used in place of and/or in conjunction with the spray nozzle 80 to achieve the function suggested herein.

The paint assembly 95 also consists of a horizontal movement device 85. The horizontal movement device 85 is encased in a housing 87 that surroundably mounts the horizontal support track 70. The housing 87 is manufactured of metal or other suitable material. The housing 87 encases the horizontal movement device 85, which is but not limited to a common electric motor with a shaft and pinion gear designed to mesh with the apertures of the horizontal support track 70. As the pinion gear rotates, the teeth mesh with the apertures of the horizontal support track which moves the paint assembly 95 in a generally X-axis direction.

Sealably mounted to one side of the housing 87 is a plurality of paint storage cells 20. The paint storage cells 20 consist of bottles constructed of plastic or other suitable material. Although it is not shown it is contemplated within the scope of this invention that the paint storage cells 20 could comprise of a variety of sizes suitable for desired applications. Those skilled in the art will recognize that many different types of readily available paint sprayers could be used in place of and/or in conjunction with the paint assembly 95 to achieve the functions suggested herein of the paint assembly 95.

The control system 40 operates the automated paint application apparatus 100. The control system 40 consists of but is not limited to a portable laptop computer. The control system 40 contains a software program that allows the user to input the dimensions of the surface that is desired for coating application. The control system 40 allows for the user to include areas, which are not to be coated during the application such as but not limited to doors and windows of an interior or exterior wall. Alternatively, the control system 40 could receive feedback from the sensors or lasers mounted to the vertical support members 50 and the horizontal support track 70 to control the area that is to be applied with the coating. The control system 40 has a plurality software programs to allow the user to program the automated paint application apparatus 100 for simple applications such as but not limited to the application of a single coat of paint to a desired surface or complex applications such as the reproduction or image transfer of a photograph or complicated design that has been inputted into the software program of the control system 40. The control system 40 is linked to the automated paint application apparatus 100 via the interface cable 15, which consists of but is not limited to a standard RS-232 or LAN cable. Those skilled in the art will recognize that many alternatives of control systems and interface methods could be used in order to achieve the functions suggested herein of the control system 40.

Referring in particular to the drawings submitted herewith, a description of the operation of the automated paint application apparatus 100 is as follows. In use, a user would assemble the vertical support members 50 to the desired length. A vertical coupling 55 with mounting plates 57 is then mounted to each vertical support member 50. An attachment bracket 72 is secured by a suitable mechanical method to one end of each of the vertical support members 50. A horizontal support beam 75 is assembled to the desired length. The user, into each attachment bracket 72 perpendicular to each adjacent vertical support member 50, inserts the horizontal support beam 75. Opposite the attachment bracket 72, an attachment mechanism 90 is mounted by suitable mechanical methods to each end of the vertical support members 90. The entire automated paint application apparatus 100 is then secured to the ground or other structure. Next, the horizontal support track 70 is assembled to the desired length. The horizontal support track 70 is then fastened by suitable mechanical methods to each of the vertical couplings 55 that are mounted to the vertical support members 50.

Subsequently, the paint storage cells 20 are filled with the desired paint or coating material. The paint storage cells 20 are then mounted to the housing of the paint assembly 95. The user then mounts the paint assembly 95 to the horizontal support track 70. The user then connects one end of the wiring harness 30 to the paint assembly 95 and the other end of the wiring harness 30 to the power supply 10. Next, the user connects one end of a 120V power cord to the junction box 12 and the other end to an available power source. The user then connects one end the interface cable 15 to the junction box 12 and the opposite end to the control system 40. The control system 40 is programmed with the desired dimensions of the area to be painted or programmed with a specific image to be painted. The user then initiates the program of the control system 40 to start the application of the paint coating or the painting of the image in the program.

Upon initiation of the control system 40, the control system will position the paint assembly 95 to the desired starting position which could be but is not limited to the top of the inputted dimension furthermost to one side. The control system 40 maneuvers the paint assembly 95 laterally, or X-axially, across the horizontal track 70 via instructions sent to the horizontal movement device 85.

Vertical or Y-axial movement is controlled by the control system 40 sending instructions to the vertical movement devices 60. When a detailed or high-resolution image has been programmed into the control system 40 for reproduction on a desired surface, the control system 40 will move the paint assembly 95 axially in the X and Y direction as needed to reproduce the image.

The control system 40 also controls the flow of paint through the spray nozzle 80 to correspond to the amount needed depending on the type of image being reproduced. For example, the control system 40 would send instructions to the spray nozzle 80 to use a different amount of paint if the desired application is a single coat of paint as opposed to a complex graphic image. During the replication of a complex image, the control system 40 will send instructions to the paint assembly 95 not only to control the flow of the paint through the spray nozzle 80 but the control system 40 will also direct the type of coating needed from each different paint storage cell 20 needed to reproduce the inputted image.

The control system 40 will also monitor the amount of coating material in the paint storage cells 20 and halt the process when at least one paint storage cell 20 becomes substantially depleted. The control system 40 will then alert the user to refill a particular paint storage cell 20 and upon filling the user can resume the coating application at the point that the process had been halted. Once the desired coating or image has been applied to the chosen surface, the automated paint application apparatus 100 can be used to apply at least one coating of a sealant such as but not limited to a weatherproof polyurethane.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An apparatus for the application of a coating material to a surface, comprising:
a first and a second support member;
a track mounted generally between said first and second support members;
a paint assembly movably secured to said track, said paint assembly for containing and applying the desired coating material;
a first means for moving said paint assembly on said track; and
a controller for at least controlling said paint assembly.

2. The apparatus as recited in claim 1, and further comprising a third support member connected between said first support member and said second support member.

3. The apparatus as recited in claim 1, wherein said track being movably mounted between said first support member and said second support member.

4. The apparatus as recited in claim 3, and further comprising a second means for moving said track along said first support member and said second support member.

5. The apparatus as recited in claim 1, wherein said controller further for controlling said first means.

6. The apparatus as recited in claim 4, wherein said controller further for controlling said second means.

7. The apparatus as recited in claim 1, wherein said controller includes a input for receiving data corresponding to the application of the coating material.

8. The apparatus as recited in claim 1, wherein said paint assembly includes a plurality of cells for receiving the desired coating materials.

9. An apparatus for the application of a coating material to a surface, comprising:
a first and a second support member;
a track movably mounted generally between said first and second support members;
a paint assembly mounted to said track, said paint assembly for containing and applying the desired coating material;
a first means for moving said track between said first support member and said second support member; and
a controller for at least controlling said paint assembly.

10. The apparatus as recited in claim 9, wherein said paint assembly being movably mounted to said track.

11. The apparatus as recited in claim 10, and further comprising a second means for moving said paint assembly on said track.

12. The apparatus as recited in claim 1 1, wherein said controller further for controlling said first means and said second means.

13. The apparatus as recited in claim 12, wherein said controller includes a input for receiving data corresponding to the application of the coating material.

14. The apparatus as recited in claim 13, wherein said paint assembly includes a plurality of cells for receiving the desired coating materials.

15. The apparatus as recited in claim 14, wherein said controller includes a computer.

16. The apparatus as recited in claim 16, wherein said computer contains programs designed to control said paint assembly in applying the coating material to the surface to correspond with an image stored said computer.

17. A method of applying a coating to a surface, comprising:
assembling a first support member and a second support member;
mounting a track generally between the first and second support members,
such that the track is movable between the first and second support members;
mounting a paint assembly mounted to the track;
controlling the movement of the track with a controller;
applying the coating to the surface with the paint assembly;
controlling the applying of the coating with the controller.

18. The method as recited in claim 17, wherein the paint assembly is movably mounted to the track and the controller controls the movement of the paint assembly along the track.

19. The method as recited in claim 18, further comprising mounting a third support member between the first and second support members.

20. The method as recited in claim 19, wherein the controller includes a computer for controlling the applying of the coating to the surface.
